(19) United States
(12) Patent Application Publication
(10) Pub. No.: US 2020/0307862 A1
(43) Pub. Date: Oct. 1, 2020

(54) STORAGE CONTAINER WITH LABEL

(71) Applicant: Jeff Green, Beverly Hills, CA (US)

(72) Inventor: Jeff Green, Beverly Hills, CA (US)

(21) Appl. No.: 16/363,904

(22) Filed: Mar. 25, 2019

(51) Int. Cl. B65D 25/20; B65C 1/02; B65D 21/02; G09F 3/00

(52) U.S. Cl. CPC B65D 25/205; B65C 1/02; B65D 21/0233; G09F 2003/0229; G09F 3/0297; G09F 3/0288; B65D 21/0219

(57) ABSTRACT

A storage container has an interior volume defined by a bottom, two side walls and two end walls, and a packaging label affixed to an outer surface of a wall, the label having a first portion with first pre-printed material, and a second portion with a surface adapted to receiving written marking, including content information marked by a purchaser or user.

### BACKGROUND

### 1. Field

Some embodiments of the present disclosure relate to storage containers and labels, in particular, storage containers with affixed labels.

### 2. Description of the Related Art

Recent research reports that hoarding, or at least the habit to store and keep, is on the rise. Consumers have a tendency to hold on to merchandise, including outdated clothing and shoes, books and old electronics, and seasonal items such as winter wear and holiday decorations. Many believe these items will be used again in the future and will store these items even despite arguments with family members or roommates. Some surveys have shown that nearly half of all residents experience panic, anxiety or stress at the thought of a guest seeing the clutter in their homes and the clutter may be transferred to a closet, a spare bedroom, the attic or the basement.

It is not surprising that storage unit complexes have also become popular. Self-service storage has become an industry in the United States. As of 2018, the number of storage facilities in the United States is estimated to range between 44,000 and 52,000. Death, divorce, downsizing and dislocation are believed to be main factors driving the need or desire for storage space rental.

Whether storing, decluttering or relocating, storage containers or storage bins have a role to play. Multiple storage containers are often used and stored together such that the owner may not remember the contents of each container. Without such content information or description, a user resorts to opening the lids at the very least, if not also unstack and restack multiple storage containers, to gain access into the storage containers and determine the contents. Conventional blank office or stationery labels may be written upon with content information and affixed to the storage containers but the adhesive carried on these conventional labels is typically intended for affixation to paper and not plastic or injection-molded surfaces. As such, such conventional labels can detach after a rather short period of time and the user, again, is without convenient content information or description.

Commercial-grade packaging labels come affixed to storage containers by means of industrial adhesive, for example, tackified acrylics, such as those described in U.S. Pat. No. 5,695,837. As such, commercial-grade packaging labels affixed to storage containers at or near the time of manufacture can remain affixed to the storage container for the entire useful live of the container. However, commercial-grade packaging labels are typically filled with pre-printed matter such that there is little, if any, blank space for a person to write on or otherwise mark with information, including content information or description.

Accordingly, there is a need for a storage container that includes a durable packaging label that can remain affixed to the container, displays packaging information for the manufacturer and provides a portion on which a purchaser or user can write or mark with content information or description.

The above information is only for enhancement of understanding of the background of embodiments of the present disclosure, and therefore may contain information that does not form the prior art.

### SUMMARY

Some embodiments of the present disclosure provide a storage container having an interior volume defined by a bottom, two side walls and two end walls, and a label affixed to an outer surface of a wall, the label having a first portion with first pre-printed material, and a second portion with a surface adapted to receiving written marking.

In some embodiments, the second portion spans an area ranging between about 20% and 100% of an area of the first portion.

In some embodiments, the second portion spans an area ranging between about 10% and 50% of the area of the label.

In some embodiments, the second portion spans an area of at least about 4.0 square inches.

In some embodiments, the first portion is without a generally blank area that is generally free of pre-printed material and spans at least 20% of the area of the first portion.

In some embodiments, the first pre-printed material includes one of the group consisting of trademark, bar code, and manufacturer information.

In some embodiments, the second portion includes second pre-printed material.

In some embodiments, the second pre-printed material includes instructive text.

In some embodiments, the second pre-printed material includes writing lines.

In some embodiments, the storage container includes a lid.

In some embodiments, the storage container includes one or more additional second portions.

Some embodiments of the present disclosure provide a method of packaging a storage container, that includes providing a storage container with a bottom, two side walls and two end walls and affixing a label to an outer surface of a wall, the label having a first portion with first pre-printed material, and a second portion with a surface adapted to receiving written marking.

In some embodiments, the second portion spans an area ranging between about 20% and 100% of the area of the first portion.

In some embodiments, the second portion spans an area ranging between about 10% and 50% of the area of the label.

In some embodiments, the second portion spans an area of at least about 4.0 square inches.

In some embodiments, the first portion is without a generally blank area that is generally free of pre-printed material and spans at least 20% of the area of the first portion.

In some embodiments, the first pre-printed material includes one of the group consisting of trademark, bar code, and manufacturer information.

In some embodiments, the second portion includes second pre-printed material.

In some embodiments, the second pre-printed material includes instructive text.

In some embodiments, the second pre-printed material includes writing lines.

In some embodiments, the container comprises a lid.

In some embodiments, the method of packaging a storage container includes providing one or more additional second portions configured for affixation onto the second portion.

### BRIEF DESCRIPTION OF THE DRAWINGS

Some embodiments can be understood in more detail from the following description taken in conjunction with the accompanying drawings, in which:

FIG. 1 is an exploded perspective view of a container with a lid, according to an embodiment of the present invention.

FIG. 2 is a perspective view of the container of FIG. 1 nested in another container.

FIG. 3 is a perspective view of the container of FIG. 1 stacked with another container.

FIG. 4 is an end view of the container of FIG. 1.

FIG. 5 is a plan view of a label, according to an embodiment of the present invention.

FIG. 6 is a plan view of a label, according to a second embodiment of the present invention.

FIG. 7 is a plan view of a label, according to a third embodiment of the present invention.

FIG. 8 is a plan view of a label, according to a fourth embodiment of the present invention.

FIG. 9 is a plan view of a label, according to a fifth embodiment of the present invention.

FIG. 10 is a plan view of a label, according to a sixth embodiment of the present invention.

FIG. 11 is a plan view of a label, according to a seventh embodiment of the present invention.

FIG. 12 is a plan perspective view of a stack of second portions, according to an embodiment of the present invention.

FIG. 13 is a partial plan view of a second portion with markings indicative of contents.

FIG. 14 is a plan view of additional second portions, according to an embodiment of the present invention.

FIG. 15 is a plan view of a label, according to an eight embodiment of the present invention.

FIG. 16 is a side cross-sectional view of the label of FIG. 15.

### DETAILED DESCRIPTION

Features of the inventive concept and methods of accomplishing the same may be understood more readily by reference to the following detailed description of embodiments and the accompanying drawings. Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, descriptions thereof will not be repeated. The drawings are not necessarily to scale and the relative sizes of elements, layers, and regions shown may be exaggerated for clarity.

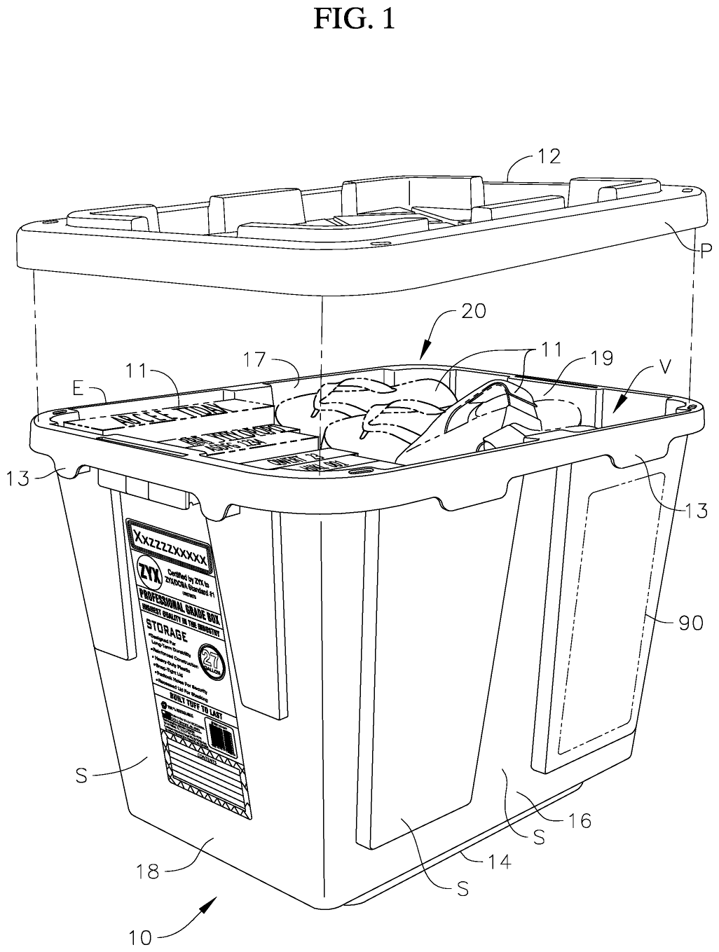

Embodiments of the present disclosure as shown in FIG. 1 include a storage container (or bin) 10 which may include a lid 12, either or both of which may be constructed of injection-molded plastic, as known in the art. Suitable construction materials include, for example, polypropylene (PP) and high-density polyethylene (HDPE). The storage container 10 has an interior volume V configured to receive for storage and safe-keeping a variety of goods 11, including, for example, books, clothing, shoes, linens, etc., which may be placed inside the container 10 by a user and protected from the elements, especially when enclosed in the interior volume by the lid 12. The storage container has a bottom 14, first and second side walls 16 and 17, and first and second end walls 18 and 19, which together define the interior volume V. Upper edges E of the walls 16, 17, 18 and 19 define an opening 20 into the interior volume V that is sealed by the lid 12 when placed on upper edges E of the walls 16, 17, 18 and 19. Upper edges E and a periphery P of the lid 12 may be configured with formations 13 that releasably interlock the lid 12 and container 10 to each other.

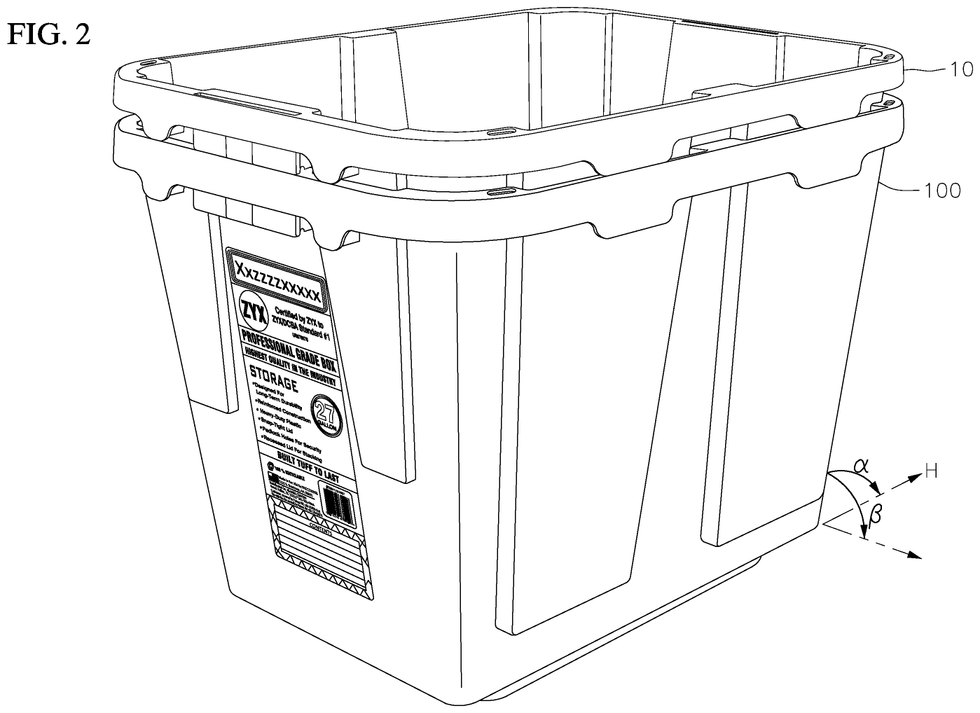

In some embodiments, the container 10 is configured to nest within a second empty container 100 of generally identical or similar configuration, as shown in FIG. 2. Nesting the containers 10 and 100 efficiently minimizes the occupation of space by the two containers. In that regard, the walls 16, 17, 18 and 19 are arranged to extend at predetermined angles α and β at less than 90 degrees from the horizontal axis H so that the walls slant outwardly, resulting in the bottom 14 defining a smaller area relative to a larger area defined by the opening 20 and the lid 12.

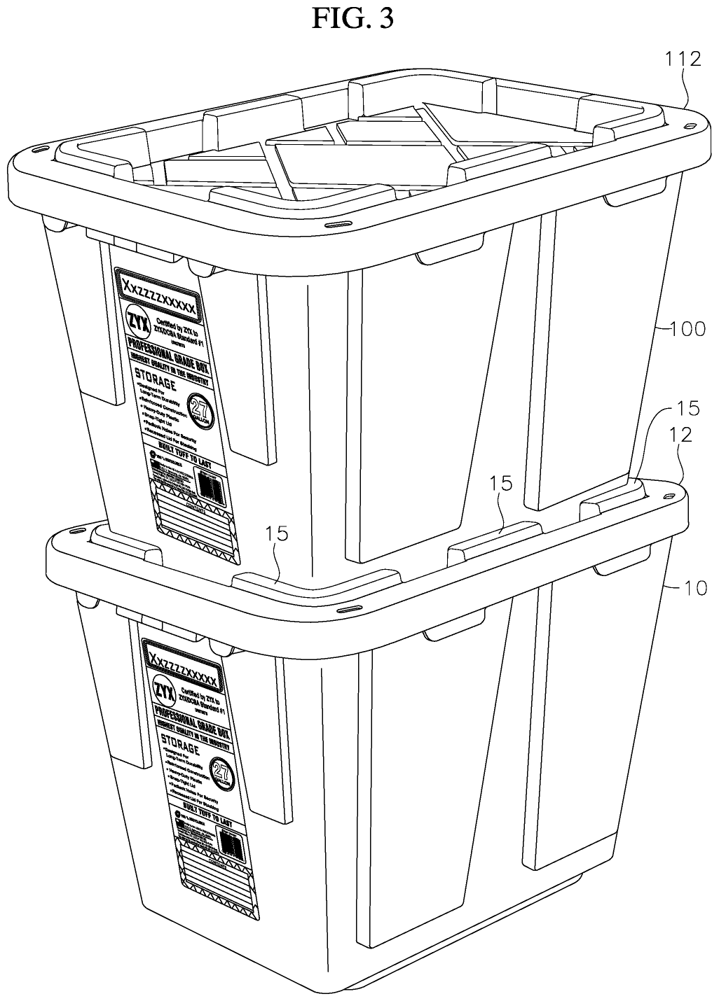

In some embodiments, the containers 10 and 100 when closed with respective lids 12 and 112 are configured to be conveniently stackable with the upper container supported on top of the lid of the lower container, as shown in FIG. 3. Raised formations 15 on the lids secure the container on top of each lid.

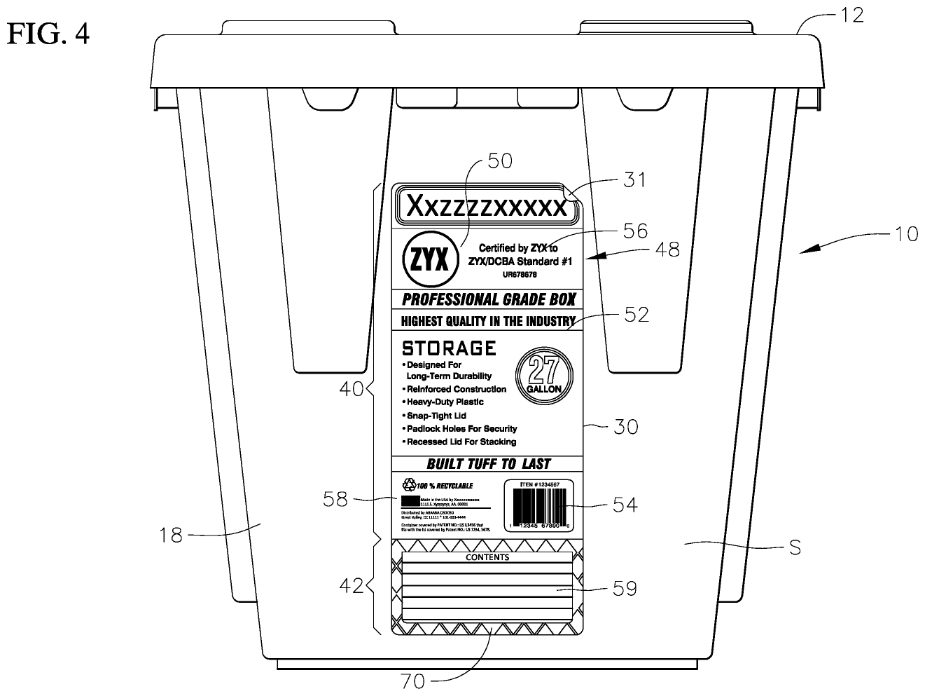

Each of the walls 16, 17, 18 and 19 has an outer surface S which is visible to a user or prospective purchaser. With reference to FIG. 4, any one or more of the outer surfaces S may support a label 30 that is affixed on a generally smooth or planar portion of the respective wall(s). The label 30 may have any suitable shape or size and has a front face and a rear face. In some embodiments, the label is generally rectangular and oriented in a “portrait” configuration but it may also be oriented in a “landscape” configuration. In some embodiments, the label 30 is sized approximately 4 inches by 10 inches. In some embodiments, the label is sized approximately 4 inches by 9.5 inches.

In some embodiments, the label 30 is affixed by a suitable adhesive 31, for example, tackified acrylic adhesives, that is applied to a rear face of the label. In some embodiments, the label 30 is constructed from a sheet or substrate material, for example, semi-gloss facestock. The suitable adhesive 31 and/or the construction of the sheet material enable the label 30 to remain generally intact and affixed to the storage container for a relatively long duration, if not for the entire service life of the container 10. As known in the art, tackified acrylic adhesives are suitable adhesives for adhesion to different surfaces and materials. U.S. Pat. No. 5,695,837 discloses tackified acrylic adhesives.

Advantageously, the label 30 includes a first portion 40 and a second portion 42, both rear faces of which have a coating or application of a suitable adhesive 31, including tackified acrylic adhesive. In some embodiments, the first portion 40 is generally equal in size to the second portion 42. In some embodiments, the first portion 40 is larger than the second portion 42, for example, about two to five times larger. In some embodiments, the second portion 42 is larger than the first portion 40, for example, about two to five times larger. The first portion 40 includes pre-printed matter on the front face, for example, pre-printed text, logos or other visual indicia. In some embodiments, the pre-printed matter includes pre-printed packaging, promotional and/or marketing matter 48 to inform and/or attract attention of a reader and/or induce a prospective buyer and/or user of the storage container. In some embodiments, as illustrated in FIG. 4, the pre-printed data includes one or more of the following: trademark (including text and/or design source identifier) 50, descriptive or promotional text 52, bar code 54, certification notice 56, and manufacturer's information 58.

In some embodiments, the first portion 40 is occupied primarily by the pre-printed matter such that the first portion 40 is without a generally blank area that can be of any shape (e.g., rectangular, circular, polygonal, irregular, etc.), is generally devoid of pre-printed text and spans an area that is about equal to at least about 20% of the total surface area of the first portion 40, for example, 20%, 30%, 40% or 50% of the total surface area of the first portion 40. In some embodiments, the label 30 is without a generally blank area that is larger than approximately 4.0 square inches, regardless of the size of the label 30 or the size of the first portion 40. As such, there is relatively little unoccupied area in the first portion 40 in which a purchaser or user can write, mark or otherwise insert text or other visual indicia without overlapping the pre-printed data of the first portion 40. Without such a generally blank area, the label 30 does not invite a user to write any text or make any marking on the label, including any text or marking descriptive or representative of the contents of the storage container on which the label was affixed at or near the time of manufacture of the storage container or at least at a time prior to the display or presentation of the storage container at a store or on a store shelf for purchase by a prospective user.

Advantageously, the second portion 42 includes a markable surface 59 on which a purchaser or user can write, mark or otherwise apply visual indicia with a writing instrument, for example, a pencil, an ink pen, a ballpoint pen, a highlighter and/or a permanent marker, or one or more stickers. The visual indicia may be words, notations or other information that readily and conveniently convey to a reader the contents inside the storage container 10. Not only does the surface 59 provide a writing or otherwise markable surface, it also provides a surface or suitable substrate onto which a conventional office or stationery label can be affixed and adhere with greater security compared to adhesion of a conventional office or stationery label directly onto the surface of a storage container, especially of the plastic or injection-molded type, e.g., constructed of polypropylene or the like.

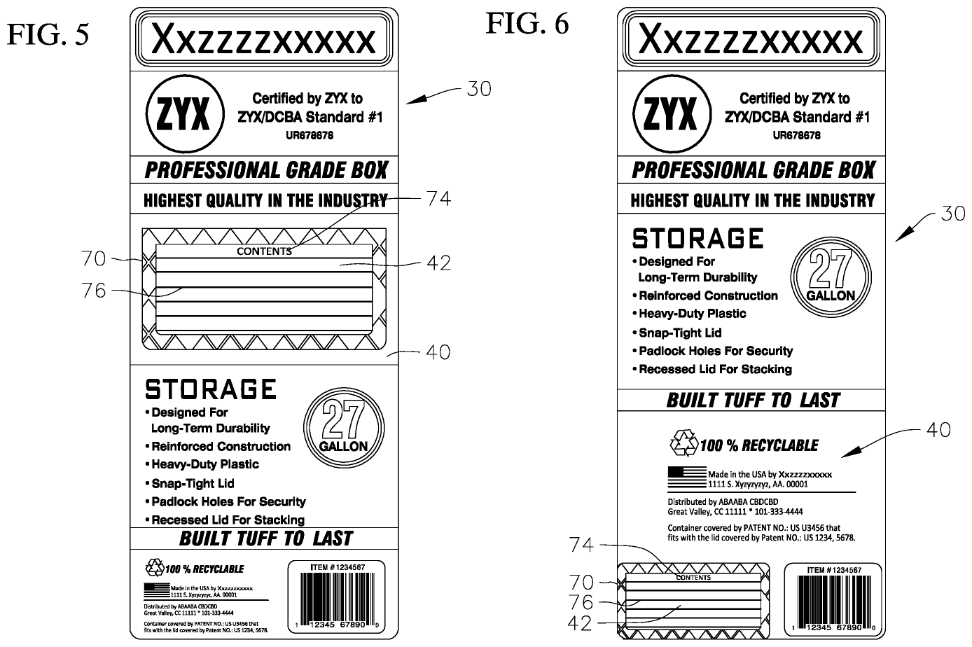

In some embodiments, the second portion 42 is surrounded in its entirety by the first portion 40, as shown in FIG. 5. In some embodiments, the second portion 42 shares one common edge with the first portion 40, as shown in FIG. 1. In some embodiments, the second portion 42 shares at least two common edges with the first portion 40, as shown in FIG. 6, such that the second portion 42 occupies a corner of the label 30.

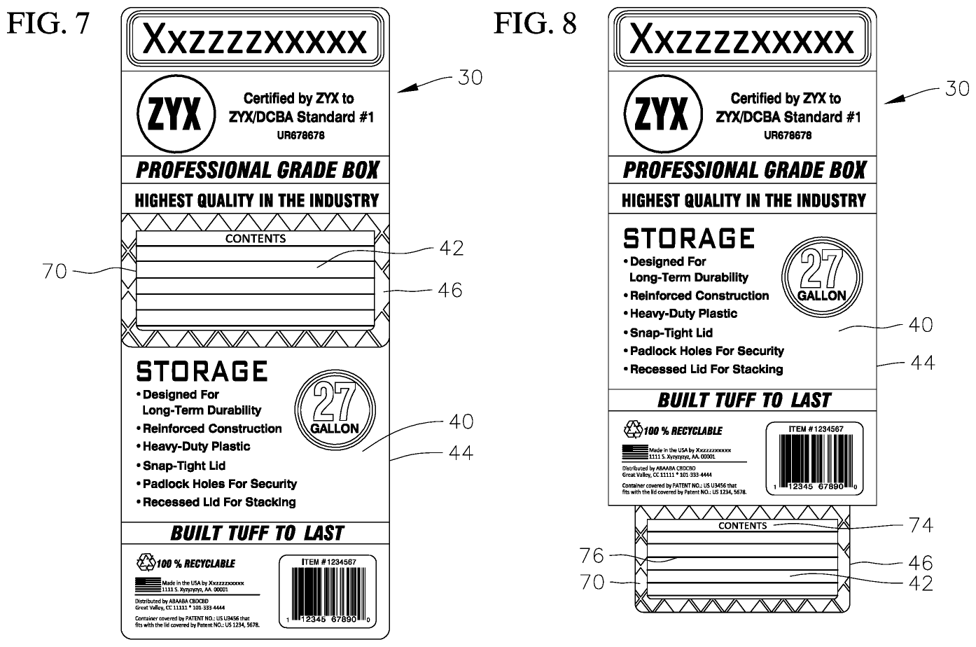

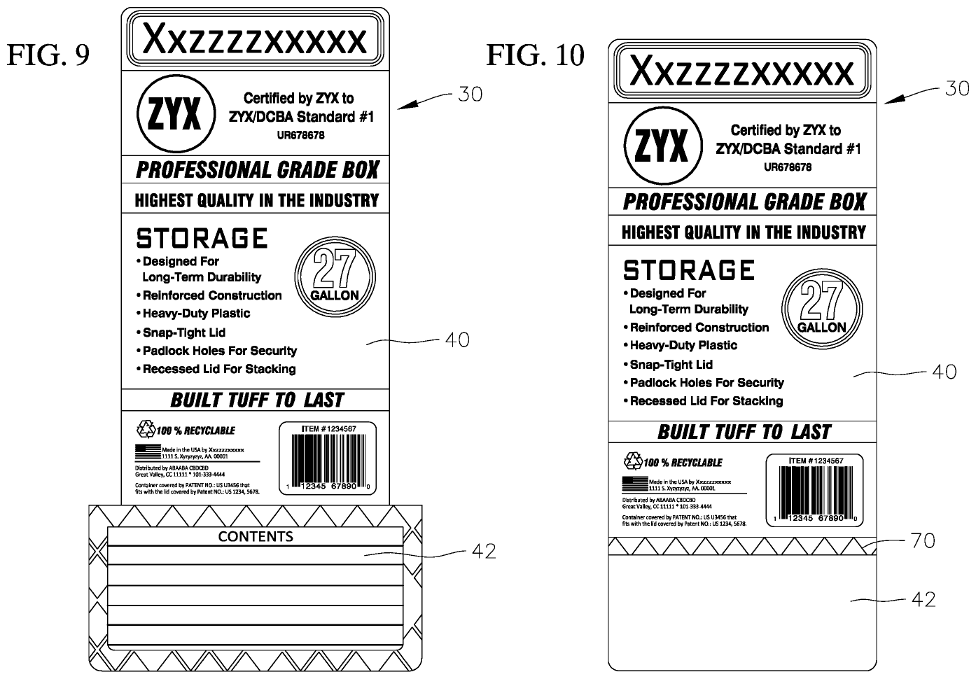

In some embodiments, the second portion 42 has one or more outer edges 46 that have continuous trajectories with one or more outer edges 44 of the first portion, as shown in FIG. 7. In FIG. 7, the second portion 42 has, for example, the same width as the first portion 41. In some embodiments, the second portion 42 has one or more edges 46 that have different trajectories than one or more connected outer edges 44 of the first portion, as shown in FIG. 8 and FIG. 9. In FIG. 8, the second portion 42 has, for example, a lesser width than the first portion 41.

In some embodiments, the area of the second portion 42 ranges between about 10% to 50% of the total area of the label 30. In some embodiments, the second portion 42 is at least approximately 2 inches×4 inches, or spans an area of at least approximately 8 square inches regardless of the area of the first portion 41 or the label 30.

In some embodiments, the label 30 includes a pre-printed visual demarcation or boundary 70 that highlights the second portion 42 and/or visually delineates the second portion 42 from the first portion 40. The boundary 70 may extend between the first and second portions 40 and 42, dividing them, as shown in FIG. 10, or it may surround the second portion 42 in its entirety, as shown in, for example, FIG. 4, FIG. 7, and FIG. 8. The boundary 70 may also, for example, display a pre-printed contrasting color and/or a pre-printed contrasting pattern relative to the first portion 40. The second portion 42 may also include pre-printed instructive text or visual indicia, for example, the word “CONTENTS” 74 and/or writing lines 76 that invite a purchaser or user to write on the second portion 42. The second portion 42 may also have a portion completely devoid of any pre-printed matter, as shown in FIG. 10.

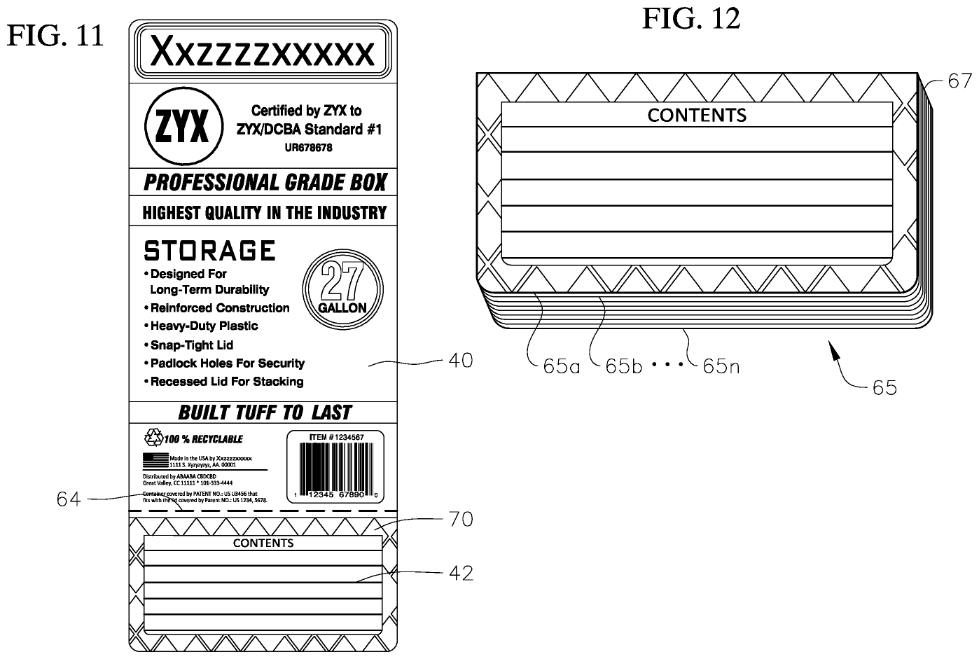

In some embodiments, the sheet material of the label 30 may include perforations 64, for example, along the boundary 70, as shown in FIG. 11, so as to facilitate separation and detachment of the second portion 42 from the label 30 and the storage container 10.

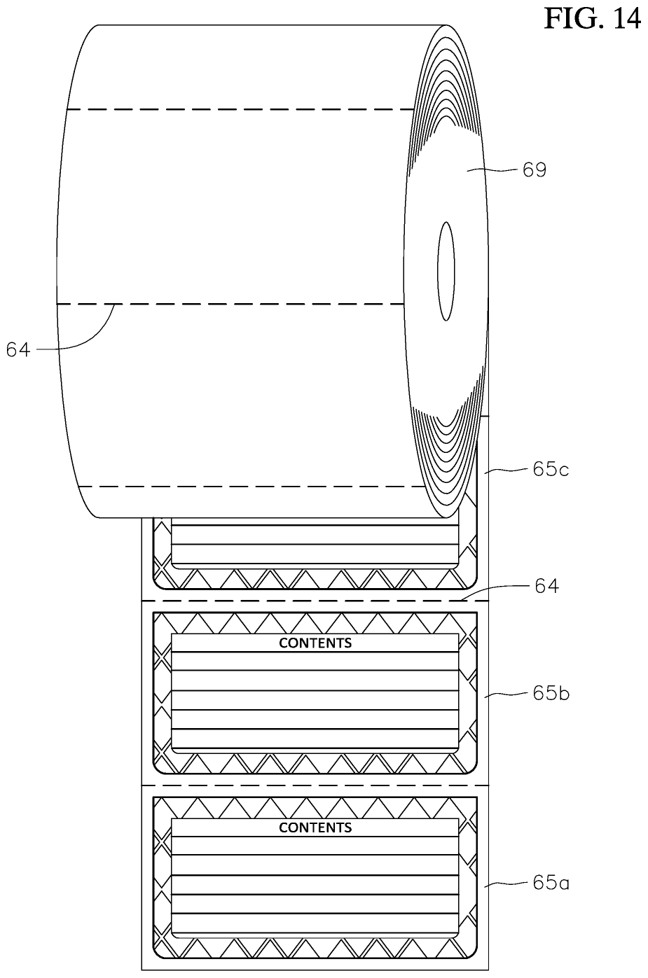

In some embodiments, the storage container 10 bearing the label 30 is sold or otherwise presented in the accompaniment of one or more additional second portions 62, for example, as a kit with the storage container bearing the label 30 and one or more replacement “Content” labels. In some embodiments, each additional second portion 62 has a similar or identical construction to the construction of the second portion 42 affixed to the storage container 10, with a similar appearance, shape and size and similar construction material and adhesive. Each additional second portion 62 is presented as separate and independent of the label 30 and may have a detachable release liner adhered to the coating of adhesive 31 on the rear face of the second portion 62, where each additional second portion 62 is configured for affixation and adhesion generally over and on top of the initial or prior second portion 42, as a replacement to occlude the initial or prior second portion 42. In some embodiments, the extra second portions 62a-62n may be arranged as a stack 65, as shown in FIG. 12, and bound by an adhesive coating on a common edge 67 of each extra second portion 62 such that they are arranged as a booklet from which each second portion 62i may be detached along the common edge. In some embodiments, the extra second portions 62a-62n are arranged adjacent to each other as part of a larger sheet or roll 69, as shown in FIG. 14, separated by, for example, perforations 64 to facilitate detachment from each other.

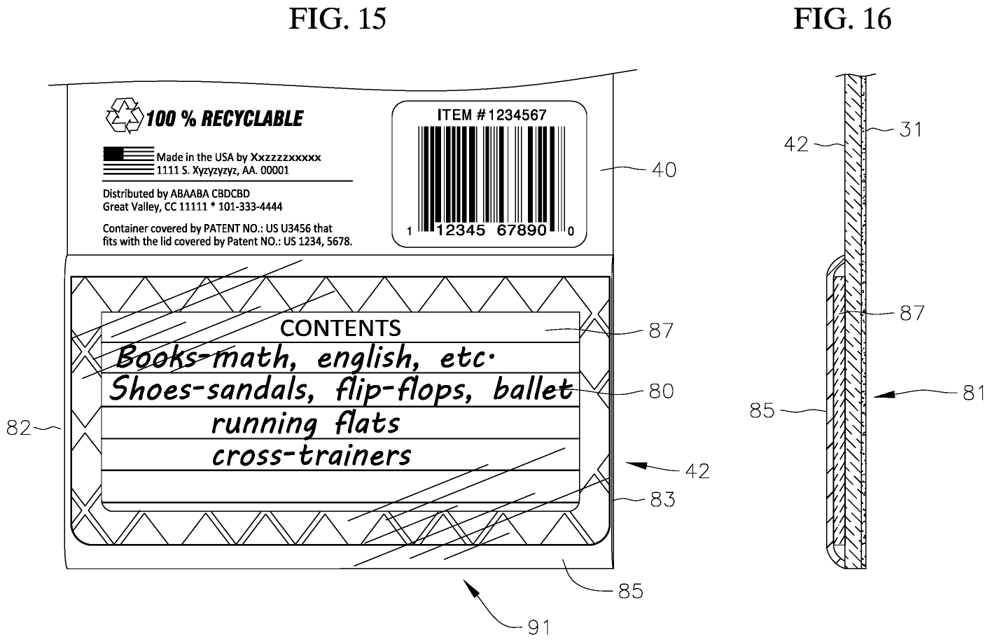

With reference to FIG. 15, some embodiments of the label 30 include a sleeve or pocket 91 in the region of the second portion 42 which is configured with an interior to receive a sheet or card insert 87, including for example, an additional second portion 62 that may display updated or revised content description for the storage container. In some embodiments, the pocket 91 includes an outer portion or sheet 86 that is transparent and overlies the second portion 42, as shown in FIG. 16. The pocket 91 may be opened ended at its opposing sides 82 and 83 (for example, left and right in FIG. 15), or it may be sealed at one end, for example, side 82. The pocket 91 may also be sealed at three sides with only one side (for example, an upper side) of its four sides unsealed to allow insertion and removal of the sheet or card insert 87 from the sleeve or pocket 91.

In use, the label 30 in its entirety, with portions 40 and 42, is securely affixed to the outer surface S of the storage container 10 by suitable commercial or industrial grade adhesive, for example, tackified acrylic adhesive, such that it remains generally intact and affixed for a significant duration, if not through the entire service life of the storage container 10. The affixation and adhesion occurs as part of the manufacturing and packaging of the storage container before the storage container is displayed or presented for sale to customers. The first portion 40 displays the pre-printed packaging matter 48 that is intended to attract and induce the prospective purchaser to purchase the storage container 10. The storage container 10 may be purchased or otherwise dispensed to a purchaser and user of the container. In some embodiments, the container 10 is sold or dispensed with one or more additional second portions 62 intended as replacements for the section portion 42 of the label 30 affixed to the storage container at the time of sale/purchase.

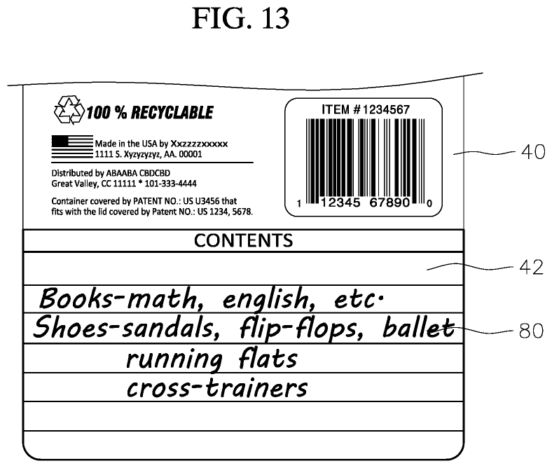

After taking possession or ownership of the storage container 10, the user can advantageously write on or otherwise mark the second portion 42 of the label 30 with any information or visual indicia 80 indicative of any contents stored in the storage container, as shown in FIG. 13. The second portion 42 displaying the instructive wording, e.g., “CONTENT” 74 and writing lines 76, invite the user to write or otherwise mark the section portion 42 with a description of the contents of the storage container. As shown in FIG. 1, it is understood that in some embodiments an additional label 90 may be affixed to an outer surface of the container 10 and/or the lid 12, as appropriate or desired, such that the user can also write or otherwise mark the second portion 42 of the label 90.

When the contents inside the storage container have changed, the user may obtain an extra second portion 62 from the stack 65 (FIG. 12) or the roll 69 (FIG. 14) and affix it to the container 10 or insert into the pocket 91 (FIG. 15 and FIG. 16) to obscure or replace the second portion 42, where the user marks the extra second portion 62 with markings indicative of new contents stored in the container 10. The user may also detach the initial second portion 42 along the perforations 64 before the user affixes the extra replacement second portion 62.

In the preceding description, for the purposes of explanation, numerous specific details are set forth to provide a thorough understanding of various embodiments. It is apparent, however, that various embodiments may be practiced without these specific details or with one or more equivalent arrangements. In other instances, well-known structures and devices are shown in block diagram form in order to avoid unnecessarily obscuring various embodiments.

Various embodiments are described herein with reference to sectional illustrations that are schematic illustrations of embodiments and/or intermediate structures. As such, variations from the shapes of the illustrations as a result, for example, of manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the particular illustrated shapes of regions, but are to include deviations in shapes that result from, for instance, manufacturing. Thus, the regions illustrated in the drawings are schematic in nature and their shapes are not intended to illustrate the actual shape of a region of a device and are not intended to be limiting.

The foregoing is illustrative of example embodiments, and is not to be construed as limiting thereof. Although a few example embodiments have been described, those skilled in the art will readily appreciate that many modifications are possible in the example embodiments without materially departing from the novel teachings and advantages of example embodiments. Accordingly, all such modifications are intended to be included within the scope of example embodiments as defined in the claims. In the claims, means-plus-function clauses are intended to cover the structures described herein as performing the recited function and not only structural equivalents but also equivalent structures. Therefore, it is to be understood that the foregoing is illustrative of example embodiments and is not to be construed as limited to the specific embodiments disclosed, and that modifications to the disclosed example embodiments, as well as other example embodiments, are intended to be included within the scope of the appended claims. The inventive concept is defined by the following claims, with equivalents of the claims to be included therein.

1.-22. (canceled)

23. A storage container, comprising:
a main body with an interior volume defined by a bottom, two side walls and two end walls;
a detachable lid; and
a label fixedly adhered to an outer surface of one of the walls, the label having a surface area having:
a first portion with first pre-printed material;
a second portion with second pre-printed material and a writing surface configured to receive information to be applied by a purchaser; and
a pre-printed demarcation between the first and second portions,
wherein the first pre-printed material includes marketing information to induce purchase of the storage container by the purchaser, the second pre-printed material includes a word “CONTENTS”,
wherein the writing surface of the second portion ranges between about 10% to 50% of the surface area of the label, and
wherein the first portion is without a generally blank area that is devoid of pre-printed material and the generally blank area is about equal to at least about 20% of the first portion.

24. The storage container of claim 23, wherein the label includes a coating of tackified acrylic adhesive.

25. The storage container of claim 23, wherein the second portion spans an area of about 4.0 square inches.

26. The storage container of claim 23, wherein the second pre-printed material includes writing lines.

27. The storage container of claim 23, wherein the marketing information includes at least one of the group consisting of a trademark and manufacturer information.

28. The storage container of claim 23, wherein the surface area of the label is about 4 inches×10 inches.

29. The storage container of claim 23, wherein the label in its entirety is fixedly adhered to the outer surface of a wall of the storage container.

30. The storage container of claim 23, wherein the pre-printed demarcation generally surrounds the second portion.

31. The storage container of claim 23, wherein the label is generally rectangular.

32. The storage container of claim 23, wherein the label is oriented in a portrait configuration.

33. The storage container of claim 23, wherein the walls of the storage container are slanted to provide a nesting configuration.

34. A method of packaging a storage container for sale, comprising manufacturing a storage container with a bottom, two side walls and two end walls;
manufacturing a detachable lid; and
manufacturing a label, the label having a surface area having:
first portion with first pre-printed material;
a second portion with second pre-printed material and a writing surface configured to receive information to be applied by a purchaser; and
a pre-printed demarcation between the first and second portions,
wherein the first pre-printed material includes marketing information to induce purchase of the storage container by the purchaser, the second pre-printed material includes a word “CONTENTS”, and the writing surface of the second portion ranges between about 10% to 50% of the surface area of the label, and the first portion is without a generally blank area that is devoid of pre-printed material, and the generally blank area is about equal to at least about 20% of the first portion.
fixedly adhering the label to an outer surface of a wall of the storage container prior to purchase of the storage container by the purchaser.

35. The method of claim 34, wherein the label includes a coating of tackified acrylic adhesive.

36. The method of claim 34, wherein the second portion spans an area of about 4.0 square inches.

37. The method of claim 34, wherein the second pre-printed material includes writing lines.

38. The method of claim 34, wherein the label is about 4 inches×10 inches.

39. The method of claim 34, wherein the pre-printed demarcation generally surrounds the second portion.

40. A label for fixed adhesion to a storage container having side walls, comprising:
a front side having a surface area, and a back side having a coating of adhesive;
wherein the front side has:
a first portion with first pre-printed material,
a second portion with second pre-printed material and a writing surface configured to receive writing by a purchaser, and
a pre-printed demarcation generally surrounding the second portion,
wherein the first pre-printed material includes at least one of the group consisting of a trademark and manufacturer information, the second pre-printed material includes a word “CONTENTS”, the writing surface of the second portion ranges between about 10% to 50% of the surface area of the label, the first portion is without a generally blank area that is devoid of pre-printed material, and the generally blank area is about equal to at least about 20% of the first portion.

41. The label of claim 40, wherein the adhesive includes a tackified acrylic adhesive.

42. The label of claim 40, wherein the second pre-printed material includes writing lines.

43. The label of claim 40, wherein the surface area of the label is about 4 inches by 10 inches.

44. The label of claim 40, wherein the first pre-printed material includes marketing information to induce purchase of the storage container by the purchaser.
